(19) United States
(12) Patent Application Publication
(10) Pub. No.: US 2025/0229337 A1
(43) Pub. Date: Jul. 17, 2025

(54) METHOD OF QUALIFICATION OF ADDITIVELY-MANUFACTURED METALLIC COMPONENTS

(71) Applicant: University of Tennessee Research Foundation, Knoxville, TN (US)

(72) Inventor: Sudarsanam S. Babu, Knoxville, TN (US)

(21) Appl. No.: 19/018,635

(22) Filed: Jan. 13, 2025

Related U.S. Application Data
(60) Provisional application No. 63/620,359, filed on Jan. 12, 2024.

(51) Int. Cl. B22F 10/80; B33Y 50/00; G06F 30/20; G06F 113/10

(52) U.S. Cl. CPC B22F 10/80; G06F 30/20; B33Y 50/00; G06F 2113/10

(57) ABSTRACT

A method of qualification of an additively-manufactured metallic component is set forth. The method of qualification enables more ready qualification of metallic components that are produced by additive manufacturing processes and that exhibit relatively complex geometries. The method of qualification, per certain implementations, can involve: predicting and forecasting thermal signatures of the additively-manufactured metallic components, situating in-situ and/or ex-situ sensors at least adjacent the additively-manufactured metallic component, measuring thermal-mechanical-chemical properties and signatures of the additively-manufactured metallic components at representative volume elements by way of the in-situ and/or ex-situ sensors, simulating thermal-mechanical-chemical properties and signatures of the additively-manufactured metallic components at the representative volume elements, and/or predicting and forecasting microstructural heterogeneity of the additively-manufactured metallic components.

### CROSS-REFERENCE TO RELATED APPLICATION

This application claims the benefit of U.S. Provisional Patent Application No. 63/620,359, with a filing date of Jan. 12, 2024, the contents of which are hereby incorporated by reference in their entirety.

### TECHNICAL FIELD

The present disclosure relates generally to additive manufacturing of metallic components and, more particularly, to the qualification of final components composed of metallic materials and produced by additive manufacturing processes and exhibiting complex geometries.

### BACKGROUND

In general, additive manufacturing (often abbreviated “AM”) refers to processes in which objects are created by building them layer-upon-layer. Additive manufacturing contrasts with subtractive manufacturing processes in which objects are created by cutting away at a solid block of material. Perhaps the most prevalent example of additive manufacturing is 3D printing technologies, but many other types and techniques exist. An advantage of additive manufacturing is its ready capability to produce parts of complex geometry that enable both structural and functional applications.

Past qualification procedures for an intended service and intended application of additively-manufactured metallic parts were often costly and time-consuming, and typically began with testing prismatic coupons made by the particular additive manufacturing process, followed by scaling-up to the final part geometry. Outside companies were usually relied-on in some capacity for such qualification procedures, increasing costs and timeframe and effectively restricting the past qualification procedures to larger organizations with the means to absorb these increases. The qualification procedures were hence less accessible to smaller organizations. Moreover, it has been observed that verification and validation of the coupons in past qualification procedures would not always lead to expected performance and proper qualification of the final part, and especially when the final part exhibited non-standard and complex geometries.

### SUMMARY

In an embodiment, a method of qualification of an additively-manufactured metallic component may include multiple steps. One step may involve situating a multitude of in-situ and/or ex-situ sensors at least adjacent the additively-manufactured metallic component. Another step may involve measuring thermal properties of the additively-manufactured metallic component at a multitude of representative volume elements of the additively-manufactured metallic component by way of the multitude of sensors, measuring mechanical properties of the additively-manufactured metallic component at the multitude of representative volume elements by way of the multitude of sensors, and measuring chemical properties of the additively-manufactured metallic component at the multitude of representative volume elements by way of the multitude of sensors. Yet another step may involve simulating thermal properties of the additively-manufactured metallic component at the multitude of representative volume elements, simulating mechanical properties of the additively-manufactured metallic component at the multitude of representative volume elements, and simulating chemical properties of the additively-manufactured metallic component at the multitude of representative volume elements.

In an embodiment, a method of qualification of an additively-manufactured metallic component with complex geometry may include multiple steps. One step may involve forecasting thermal signatures of the additively-manufactured metallic component. Another step may involve situating a multitude of in-situ and/or ex-situ sensors at least adjacent the additively-manufactured metallic component. Another step may involve measuring thermal signatures of the additively-manufactured metallic component at a multitude of representative volume elements of the additively-manufactured metallic component by way of the multitude of sensors, measuring mechanical signatures of the additively-manufactured metallic component at the multitude of representative volume elements by way of the multitude of sensors, and measuring chemical signatures of the additively-manufactured metallic component at the multitude of representative volume elements by way of the multitude of sensors. Yet another step may involve using the forecasted thermal signatures and the measured thermal signatures, measured mechanical signatures, and measured chemical signatures of the additively-manufactured metallic component in order to forecast microstructural heterogeneity of the additively-manufactured metallic component.

In an embodiment, a method of qualification of an additively-manufactured metallic component may include multiple steps. One step may involve forecasting spatial and temporal thermal signatures of the additively-manufactured metallic component. Another step may involve situating a multitude of in-situ and/or ex-situ sensors to take measurements at a multitude of representative volume elements of the additively-manufactured metallic component. Another step may involve measuring spatial and temporal thermal signatures of the additively-manufactured metallic component at the multitude of representative volume elements by way of the multitude of sensors, measuring spatial and temporal mechanical signatures of the additively-manufactured metallic component at the multitude of representative volume elements by way of the multitude of sensors, and measuring spatial and temporal chemical signatures of the additively-manufactured metallic component at the multitude of representative volume elements by way of the multitude of sensors. Yet another step may involve using the forecasted spatial and temporal thermal signatures and the measured spatial and temporal thermal signatures, measured spatial and temporal mechanical signatures, and measured spatial and temporal chemical signatures of the additively-manufactured metallic component in order to forecast microstructural heterogeneity of the additively-manufactured metallic component. The forecasted microstructural heterogeneity of the additively-manufactured metallic component being based at least in part on similarities exhibited among the forecasted spatial and temporal thermal signatures and the measured spatial and temporal thermal signatures, measured spatial and temporal mechanical signatures, and measured spatial and temporal chemical signatures of the additively-manufactured metallic component. The method of qualification of the additively-manufactured metallic component is initiated with an approximate end design of the additively-manufactured metallic component.

Further scope of applicability of the present disclosure will become apparent from the detailed description given hereinafter. But it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given below and the accompanying drawings, which are given by way of illustration only, and do not limit the present disclosure, and wherein:

FIG. 1 is a block diagram of an embodiment of a method of qualification of an additively-manufactured metallic component;

FIG. 2 is a schematic depiction of an embodiment of the method of qualification of an additively-manufactured metallic component;

FIGS. 3A and 3B are schematic depictions of an embodiment of the method of qualification of an additively-manufactured metallic component;

FIG. 4 is a schematic depiction of certain spatial and temporal sequences of phase transitions for consideration per an embodiment of the method of qualification of an additively-manufactured metallic component;

FIGS. 5A and 5B present experimental evidence demonstrating a correlation between perturbations in liquid-solid interface velocity and thermal signature, and resulting microstructure heterogeneity in a weld;

FIG. 6 is a schematic depiction of representative volume elements of an additively-manufactured metallic component;

FIG. 7 is a schematic depiction of spatial and temporal thermal-mechanical-chemical conditions in a representative volume element: depiction (a) shows an infrared map during a laser powder bed fusion additive manufacturing process; depiction (b) shows an asymmetric melt-pool formation during a laser powder bed fusion additive manufacturing process; and depiction (c) shows a schematic view of thermal, stress, and chemical gradients across the associated boundaries;

FIGS. 8A and 8B are schematic depictions of an embodiment of the method of qualification of an additively-manufactured metallic component;

FIG. 9 presents an overview of thermal infrared (IR) signatures measured at five separate locations identified at A, B, C, D, and E in the somewhat complex component geometry shown in the window (b);

FIG. 10 presents an overview of additive manufacturing solidification microstructure (also referred to as fish-scale) near and far from associated melt pool boundaries;

FIG. 11 is a schematic depiction in which: image (a) presents an overview of pressure retaining tube parts made via a laser powder bed fusion (L-PBF) additive manufacturing process; image (b) is a graph showing measured process data pressure, temperature, and oxygen content as a function of time for a 40-hour build; in the graph, run time (hours) is plotted on an x-axis and parameter is plotted on a y-axis; and image (c) presents burst test pressurization results for some of the geometries of image (a);

FIG. 12 is a schematic depiction demonstrating predicting solid-state transformation microstructure (cascading microstructure);

FIG. 13 is a schematic depiction demonstrating correlation of thermomechanical effects on solid-state phase transformations for additively-manufactured Ti-6Al-4V components; the graph in the figure presents strain on an x-axis and stress/MPa on a y-axis;

FIG. 14 is a schematic depiction demonstrating correlation of performance to defects for additively-manufactured Ti-6Al-4V components via an electron beam powder bed fusion (E-PBF) additive manufacturing process; the graph in the figure presents displacement/inch on an x-axis and load/lbf on a y-axis;

FIG. 15 is a schematic depiction of an overview of steps used for dissimilarity analysis in order to compare thermal signatures measured during additive manufacturing; in the figure, boxed depiction (a) shows methodology for capturing transient infrared (IR) thermal signatures, boxed depiction (b) shows time-series dissimilarity analysis, and boxed depiction (c) shows grouping of thermal signatures based on similarity index;

FIG. 16 is a schematic depiction demonstrating correlation of additive manufacturing processes to control magnetic properties, the additive manufacturing process being a laser powder bed fusion (L-PBF) process of Fe—Si soft magnetic alloy component;

FIG. 17 is a schematic depiction demonstrating correlation of additive manufacturing processes to control magnetic properties, the additive manufacturing process being a laser powder bed fusion (L-PBF) process of Fe—Si soft magnetic alloy component; and

FIG. 18 is a schematic depiction of an embodiment of kNN that can enable evaluation of relevant cluster size based on ex-situ characterization of additively-manufactured samples with the use of electron microscopy and atom probe tools.

### DETAILED DESCRIPTION

Referring generally to the drawings, embodiments of a method of qualification of an additively-manufactured metallic component is depicted in the figures and described herein. The method of qualification enables ready, rapid, and agile qualification of metallic components exhibiting relatively complex geometries produced by additive manufacturing processes and, per at least some applications, intended for employment in more extreme environments. In general, the method of qualification per at least some embodiments is based in part upon certain physical metallurgy principles involved in interactions between various phase transitions and phenomena that take place amid additive manufacturing processes. According to various embodiments and summarily presented here the method of qualification of additively-manufactured metallic components can involve one or all or a combination of: i) predicting and forecasting thermal metallurgical signatures of the additively-manufactured metallic components; ii) situating a multitude of in-situ and/or ex-situ sensors at a multitude of representative volume elements in the additively-manufactured metallic components; iii) measuring thermal-mechanical-chemical metallurgical properties and signatures of the additively-manufactured metallic components at the representative volume elements by way of the in-situ and/or ex-situ sensors; iv) simulating thermal-mechanical-chemical metallurgical properties and signatures of the additively-manufactured metallic components at the representative volume elements; and/or v) predicting and forecasting microstructural heterogeneity of the additively-manufactured metallic components. Further, the method of qualification furnishes site-specific variations of microstructure, and site-specific properties, in the subject additively-manufactured metallic component, ultimately providing the structural and functional properties of the subject representative volume elements. Moreover, unlike past qualification procedures, in at least some embodiments the method of qualification set forth herein begins with the finally-designed and final component itself, and is performed without the use of the past coupons. It is currently thought that the method of qualification can reduce overall cost and timeframe of the process by as much as, or more than, approximately fifty percent (50%) compared to past qualification procedures. Overall, a more efficient and effective qualification process is furnished for additively-manufactured metallic components, and one that is accessible to smaller and mid-sized organizations in order to larger organizations. Still, a particular embodiment of the method of qualification may exhibit only one, all, or a combination of, the advancements set forth herein, none of the advancements, or other advancements that are unmentioned.

Furthermore, as used herein, the phrase “additively-manufactured metallic component” is intended to have an expansive meaning that embraces components made by additive manufacturing processes and composed of metal materials; the precise process and material composition employed can be dictated by the particular application involved. Such additive manufacturing processes can include, but are not limited to, general processes of making 3D metal components layer-upon-layer via the interaction between a heating source and feeding material from a digital design model, directed energy deposition (DED) processes, laser powder bed fusion (L-PBF) processes, electron beam powder bed fusion (E-PBF) processes, solid-state metal additive manufacturing processes, as well as many others. Heat treatments can be subsequently carried out to the additively-manufactured metallic component. And such metallic materials can include, but are not limited to, steels, stainless steels, titanium alloys, nickel-based alloys, ferrosilicon alloys, as well as many others. Additively-manufactured metallic components include components of somewhat complex designs, shapes, and geometries that can be found in aerospace, automotive, medical, marine, and nuclear reactor applications, among many other possible applications and industries. Further, qualification refers generally to the process of determining whether a component meets specified requirements and standards for its intended use; the process conventionally involves some amount of evaluation of components including tensile-testing, impact-testing, fatigue-testing, and/or creep-testing, among other possibilities, as well as part-level testing. Certification, on the other hand, refers generally to the process of verifying that a component meets standards and requirements set by a regulatory or certification authority. Standard for manufacturing refers to a documented set of guidelines, specifications, or criteria established by authoritative bodies, organizations, or industries to ensure the uniformity, quality, safety, and efficiency of products and manufacturing processes. Such standards, in general, are used to streamline production, enhance compatibility, and maintain consistency across different manufacturers and industries.

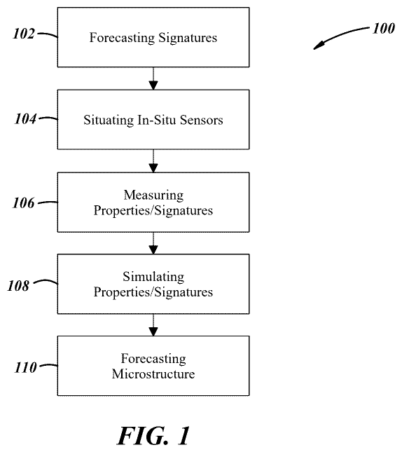

As mentioned, past qualification procedures typically began by testing coupons made by the particular additive manufacturing process, and followed by scaling-up to the final part geometry. But this approach would not always lead to the expected performance and proper qualification of the final part, and especially when the final part exhibited complex geometries. It has been determined, and is currently thought, that the primary cause of the shortcomings encountered amid past qualification procedures with coupons is due at least in part to variability of spatial and temporal thermal-mechanical-chemical signatures; still, other and/or different theories of causation and rationales are possible. With reference to FIG. 1, the method of qualification of an additively-manufactured metallic component 12 (hereafter, “method of qualification”) is generally denoted by reference numeral 100 in the figure. The method of qualification 100 can involve various steps according to various embodiments. In the embodiment of FIG. 1, the method of qualification 100 can include: a step 102 of predicting and forecasting thermal signatures of the additively-manufactured metallic component 12; a step 104 of equipping and situating multiple in-situ sensors and/or ex-situ 14 within the additively-manufactured metallic component 12; a step 106 of measuring thermal-mechanical-chemical properties and signatures of the additively-manufactured metallic component 12; a step 108 of simulating thermal-mechanical-chemical properties and signatures of the additively-manufactured metallic component 12; and a step 110 of predicting and forecasting microstructural heterogeneity of the additively-manufactured metallic component 12. Still, the method of qualification 100 could have more, less, and/or different steps than those set forth here according to other embodiments, and the steps need not necessarily be performed in the order indicated by FIG. 1.

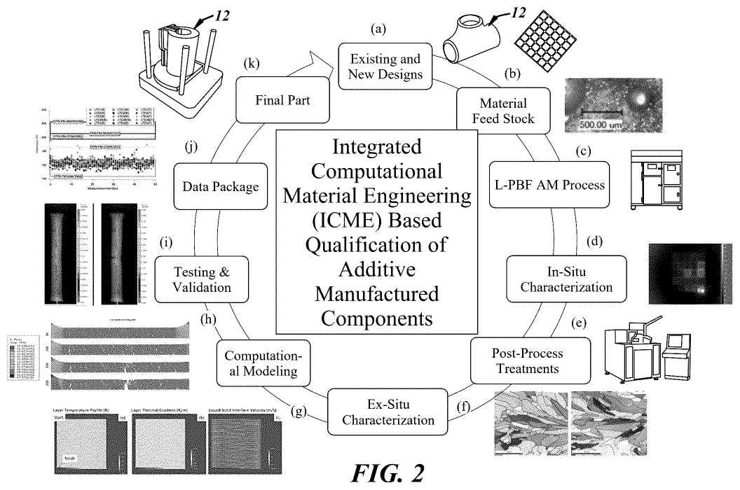

The additively-manufactured metallic component 12 can exhibit various designs, constructions, metallic material compositions, and/or components according to various embodiments. Examples of the additively-manufactured metallic component 12 are illustrated in FIGS. 2, 3A, 6, and 8A for demonstration purposes, but these are mere examples as the additively-manufactured metallic component 12 can have countless designs, constructions, metallic material compositions, and/or components. Indeed, its precise design, construction, metallic material composition, and/or components can be dictated by the particular application in which the additively-manufactured metallic component 12 will be employed for use. Because the additively-manufactured metallic component 12 is produced by an additive manufacturing process, it can exhibit a relatively complex design, shape, and geometry. Such complex components can be found in aerospace, automotive, medical, marine, and nuclear reactor applications, among many other possible applications and industries. In this regard, the additively-manufactured metallic component 12 can be an aerospace component, automotive component, medical component, marine component, nuclear reactor component, or some other component. Further, the additively-manufactured metallic component 12 can be produced via an additive manufacturing process that can include, but is not limited to, a directed energy deposition (DED) process, a laser powder bed fusion (L-PBF) process, an electron beam powder bed fusion (E-PBF) process, or a solid-state metal additive manufacturing process, as well as via many other possible additive manufacturing processes. Heat treatments can be subsequently carried out to the additively-manufactured metallic component 12, per at least some embodiments. Lastly, the additively-manufactured metallic component 12 can be composed of a metal material that can include, but is not limited to, a steel material, a stainless steel material, a titanium alloy material, a nickel-based alloy material, and/or a ferrosilicon alloy material, as well as many other possible materials.

The step 102 of predicting and forecasting thermal signatures of the additively-manufactured metallic component 12 in the method of qualification 100 can involve various sub-steps and actions in various embodiments. In an embodiment, the predicted and forecasted thermal signatures can be predicted and forecasted spatial and temporal thermal signatures of the additively-manufactured metallic component 12 that are a function of location and time, and that can be spatial resolutions (e.g., 10⁻⁹ to 10⁻³ m; precise resolutions can be dictated by target property demands) and temporal resolutions (e.g., 10⁻⁴ to 10¹ s; precise resolutions can be dictated by target property demands).

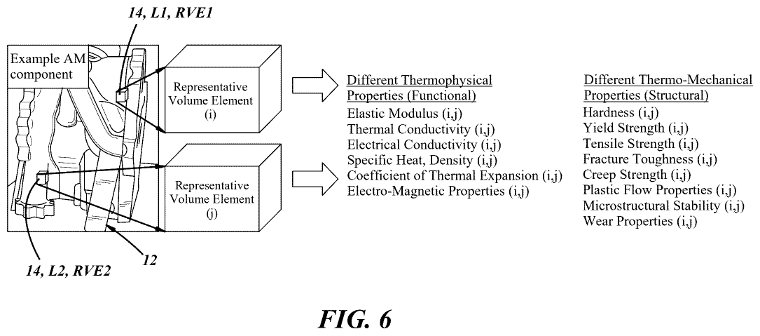

The step 104 of equipping and situating multiple in-situ and/or ex-situ sensors 14 at least at or near the additively-manufactured metallic component 12 in the method of qualification 100 can involve various sub-steps and actions in various embodiments. The in-situ and/or ex-situ sensors 14 can be sensors of different types that, in general, can sense and measure thermal properties and signatures within the additively-manufactured metallic component 12, mechanical properties and signatures within the additively-manufactured metallic component 12, and chemical properties and signatures within the additively-manufactured metallic component 12. In an embodiment, the in-situ and/or ex-situ sensors 14 can be thermal in-situ and/or ex-situ sensors, mechanical in-situ and/or ex-situ sensors, and chemical in-situ and/or ex-situ sensors 14. The in-situ sensors 14 can include an optical sensor, as an example. The various measurements can be executed by a single in-situ and/or ex-situ sensor 14 or multiple in-situ and/or ex-situ sensors 14 with certain in-situ and/or ex-situ sensors 14 dedicated to certain types and kinds of measurements, per various embodiments. In an embodiment, the in-situ and/or ex-situ sensors 14 are situated at multiple locations L within the additively-manufactured metallic component 12. The locations can be sites in the additively-manufactured metallic component 12 that are spaced and distanced from one another. FIG. 6 illustrates a first location L1 and a second location L2, as examples. Further, the multiple locations can constitute multiple representative volume elements RVEs of the additively-manufactured metallic component 12. FIG. 6 illustrates a first representative volume element RVE1 and a second representative volume element RVE2, as examples. In an embodiment, equipping and situating the in-situ and/or ex-situ sensors 14 can be within the additively-manufactured metallic component 12 can involve embedding the in-situ and/or ex-situ sensors 14 within the structure of the additively-manufactured metallic component 12, which can be carried out in the midst of the particular additive manufacturing process. In another embodiment, equipping and situating the in-situ and/or ex-situ sensors 14 can be internal to the additively-manufactured metallic component 12, external to the additively-manufactured metallic component 12, at an exterior surface of the additively-manufactured metallic component 12, and/or a combination thereof.

The step 106 of measuring thermal-mechanical-chemical properties and signatures of the additively-manufactured metallic component 12 in the method of qualification 100 can involve various sub-steps and actions in various embodiments. In an embodiment, the measured thermal and mechanical and chemical properties and signatures are taken at the representative volume elements RVEs of the additively-manufactured metallic component 12 and are by way of the in-situ and/or ex-situ sensors 14. The measured thermal properties and signatures can be measured spatial and temporal thermal properties and signatures, per an embodiment, that are a function of location and time, and that can be spatial resolutions (e.g., 10⁻⁹ to 10⁻³ m; precise resolutions can be dictated by target property demands) and temporal resolutions (e.g., 10⁻⁴ to 10¹ s; precise resolutions can be dictated by target property demands). Similarly, the measured mechanical properties and signatures can be measured spatial and temporal mechanical properties and signatures, per an embodiment, that are a function of location and time, and that can be spatial resolutions (e.g., 10⁻⁹ to 10⁻³ m; precise resolutions can be dictated by target property demands) and temporal resolutions (e.g., 10⁻⁴ to 10¹ s; precise resolutions can be dictated by target property demands); and the measured chemical properties and signatures can be measured spatial and temporal chemical properties and signatures, per an embodiment, that are a function of location and time, and that can be spatial resolutions (e.g., 10⁻⁹ to 10⁻³ m; precise resolutions can be dictated by target property demands) and temporal resolutions (e.g., 10⁻⁴ to 10¹ s; precise resolutions can be dictated by target property demands). Furthermore, the measured thermal, mechanical, and chemical properties and signatures can be analyzed and classified to provide constitutive structural and physical properties that can subsequently be back compatible with computational applied mechanics tools, furnishing part-specific qualification, per an embodiment.

In an embodiment and with reference to FIG. 6, the measured thermal and mechanical and chemical properties and signatures can be various thermophysical properties (functional) taken at the representative volume elements RVEs of the additively-manufactured metallic component 12 and by way of the in-situ and/or ex-situ sensors 14, can be various thermo-mechanical properties (structural) taken at the representative volume elements RVEs of the additively-manufactured metallic component 12 and by way of the in-situ and/or ex-situ sensors 14, or can be both various thermophysical properties and thermo-mechanical properties taken at the representative volume elements RVEs of the additively-manufactured metallic component 12 and by way of the in-situ and/or ex-situ sensors 14. The thermophysical properties can include, but are not limited to, elastic modulus properties, thermal conductivity properties, electrical conductivity properties, specific heat properties, density properties, coefficient of thermal expansion properties, and electro-magnetic properties, as well as many other possible properties. The thermo-mechanical properties can include, but are not limited to, harness properties, yield strength properties, tensile strength properties, fracture toughness properties, creep strength properties, plastic flow properties, microstructural stability properties, and wear properties, as well as many other possible properties. Further, in an embodiment, measured thermal and mechanical and chemical properties and signatures can include infrared (IR) radiation, displacement, and/or plasma emissions, among many other possibilities, taken at the representative volume elements RVEs of the additively-manufactured metallic component 12 and by way of the in-situ and/or ex-situ sensors 14.

The step 108 of simulating thermal-mechanical-chemical properties and signatures of the additively-manufactured metallic component 12 in the method of qualification 100 can involve various sub-steps and actions in various embodiments. In an embodiment, the simulated thermal and mechanical and chemical properties and signatures are taken at the representative volume elements RVEs of the additively-manufactured metallic component 12. In this regard, and per an embodiment, the simulated thermal and mechanical and chemical properties and signatures can be of the whole additively-manufactured metallic component 12. The simulated thermal-mechanical-chemical properties and signatures can be carried out via computational modeling. The computational modeling can be pragmatic fast-acting computation models. The simulated thermal properties and signatures can be simulated spatial and temporal thermal properties and signatures, per an embodiment, that are a function of location and time, and that can be spatial resolutions (e.g., 10⁻⁹ to 10⁻³ m; precise resolutions can be dictated by target property demands) and temporal resolutions (e.g., 10⁻⁴ to 10¹ s; precise resolutions can be dictated by target property demands). Similarly, the simulated mechanical properties and signatures can be simulated spatial and temporal mechanical properties and signatures, per an embodiment, that are a function of location and time, and that can be spatial resolutions (e.g., 10⁻⁹ to 10⁻³ m; precise resolutions can be dictated by target property demands) and temporal resolutions (e.g., 10⁻⁴ to 10¹ s; precise resolutions can be dictated by target property demands); and the simulated chemical properties and signatures can be simulated spatial and temporal chemical properties and signatures, per an embodiment, that are a function of location and time, and that can be spatial resolutions (e.g., 10⁻⁹ to 10⁻³ m; precise resolutions can be dictated by target property demands) and temporal resolutions (e.g., 10⁴ to 10¹ s; precise resolutions can be dictated by target property demands).

The step 110 of predicting and forecasting microstructural heterogeneity of the additively-manufactured metallic component 12 in the method of qualification 100 can involve various sub-steps and actions in various embodiments. In an embodiment, predicting and forecasting microstructural heterogeneity is based, at least in part, upon the use of the measured thermal, mechanical, and chemical properties and signatures, the use of the simulated thermal, mechanical, and chemical properties and signatures, or the use of both the measured thermal, mechanical, and chemical properties and signatures and simulated thermal, mechanical, and chemical properties and signatures. Data from the measured thermal, mechanical, and chemical properties and signatures and data and results from the simulated thermal, mechanical, and chemical properties and signatures can be spliced together. Further, in an embodiment, predicting and forecasting microstructural heterogeneity is based, at least in part, upon the use of the predicted and forecasted thermal signatures of the additively-manufactured metallic component 12. In a further embodiment, the use of the predicted and forecasted thermal signatures to predict and forecast microstructural heterogeneity can be in conjunction with the use of the measured thermal, mechanical, and chemical properties and signatures and/or the use of the simulated thermal, mechanical, and chemical properties and signatures. In an embodiment, predicting and forecasting microstructural heterogeneity is based, at least in part, upon similarities or dissimilarities exhibited and identified among the predicted and forecasted thermal signatures of the additively-manufactured metallic component 12 and the measured thermal, mechanical, and chemical properties and signatures, or the simulated thermal, mechanical, and chemical properties and signatures, or both the measured thermal, mechanical, and chemical properties and signatures and simulated thermal, mechanical, and chemical properties and signatures.

Furthermore, in an embodiment the method of qualification 100 can include a step of mapping the predicted and forecasted microstructural heterogeneity of the additively-manufactured metallic component 12 onto a computer-aided design (CAD) model of the additively-manufactured metallic component 12. The step of mapping like other steps in the method of qualification 100 can involve various sub-steps and actions in various embodiments.

Further, in an embodiment the method of qualification 100 can include a step of providing estimated component defects of the additively-manufactured metallic component 12 based, at least in part, upon the mapped and predicted and forecasted microstructural heterogeneity of the additively-manufactured metallic component 12. The step of providing estimated component defects like other steps in the method of qualification 100 can involve various sub-steps and actions in various embodiments. The estimated component defects of the additively-manufactured metallic component 12 can be based upon a probability of component defects of the additively-manufactured metallic component 12. In an embodiment, once a component defect is estimated and provided, a design change and alteration of the additively-manufactured metallic component 12 can be carried out at the location of the estimated component defect in order to resolve and preclude the defect from arising in the end and final design of the additively-manufactured metallic component 12.

As set forth, the method of qualification 100 can begin and be initiated with finally-designed additively-manufactured metallic component 12 itself, as opposed to the past qualification procedures that typically began by testing coupons made by the particular additive manufacturing process and then followed by scaling-up to the final part geometry. The method of qualification 100, per at least some embodiments, need not use the past coupons for its qualification steps. Qualification can be performed via the method of qualification 100 in the absence of past coupons. This has been shown to facilitate the qualification steps and reduce overalls costs and expedite overall timeframe for the method of qualification 100. Furthermore, in at least some embodiments, use of the method of qualification 100 can begin at, and can be incorporated into, the design stage of a particular additively-manufactured metallic component in order to deliver a qualified additively-manufactured metallic component and part in an efficient and effective manner. Overall, the expected performance of a particular additively-manufactured metallic component and part can be anticipated, and component- and part-specific qualification can be effected. As set forth herein, per at least some embodiments, in general the method of qualification can involve integration one or some or all of: i) topology optimization for structural and functional performance; ii) metallurgy; iii) process science; iv) in-situ and/or ex-situ process sensing; v) data analysis; vi) in-situ characterization; vii) ex-situ characterization, viii) integrated computational modeling and engineering; and ix) development of business case for industries for deployment of additive manufacturing.

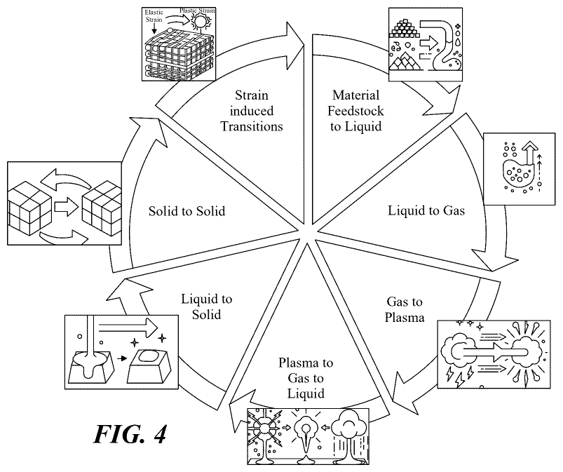

With reference now to FIG. 4, according to an embodiment, the method of qualification 100 can be employed for suitable consideration of certain spatial and temporal sequences of phase transitions. From FIG. 4, those include, but are not necessarily limited to, one or more of: material feedstock to liquid, liquid to gas, gas to plasma, plasma to gas to liquid, liquid to solid, solid to solid, and strain induced transitions.

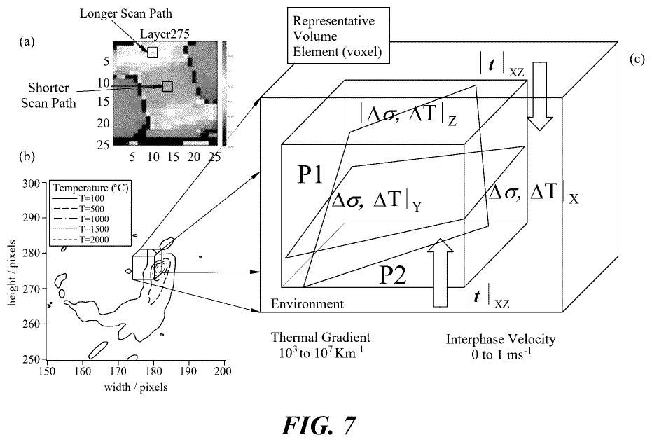

Furthermore, with reference now to FIG. 7, according to an embodiment, a schematic depiction of spatial and temporal thermal-mechanical-chemical conditions in a representative volume element is shown. Depiction (a) shows an infrared map during a laser powder bed fusion additive manufacturing process; depiction (b) shows an asymmetric melt-pool formation during a laser powder bed fusion additive manufacturing process; and depiction (c) shows a schematic view of thermal, stress, and chemical gradients across the associated boundaries.

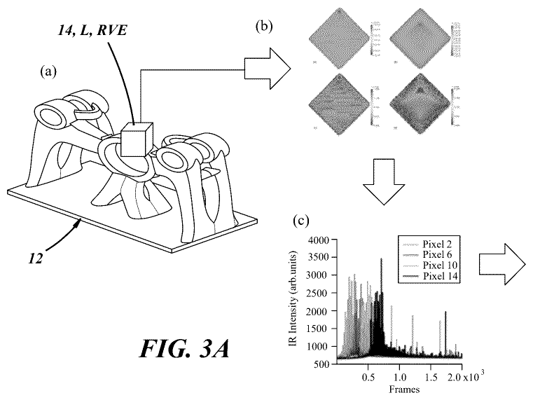

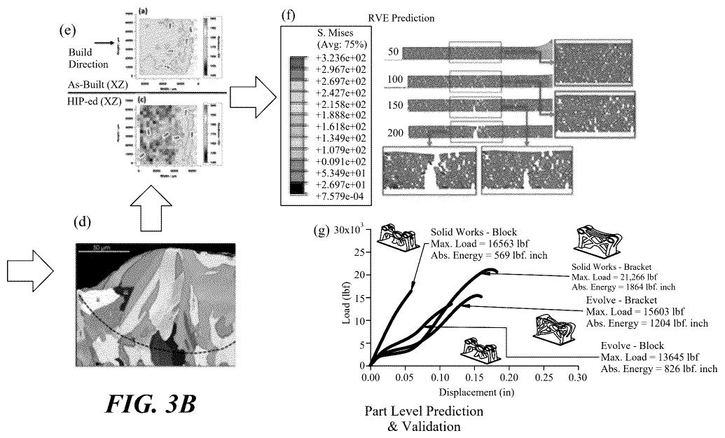

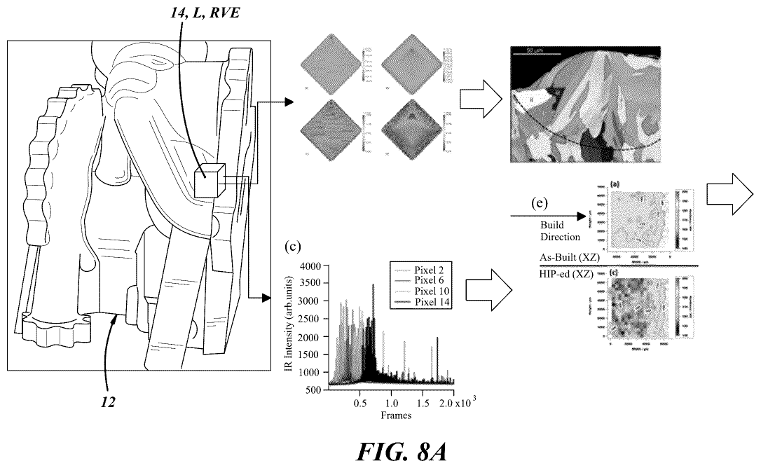

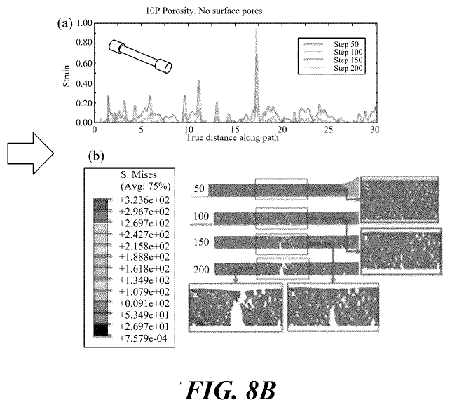

With reference now to FIGS. 3A and 3B, an embodiment of the method of qualification of an additively-manufactured metallic component is schematically depicted. It shows an overview of the method of qualification based on thermal-mechanical-chemical signatures and physical metallurgy principles, per this embodiment. A process flow of the method of qualification is outlined in the figures. The process flow begins with the design of the additively-manufactured metallic component 12 for the particular application (FIG. 3A shows an example metallic bracket component that was designed with a commercial topology optimized part). Next, per this embodiment, using equipment-specific processing details, the expected thermal signatures are predicted and forecasted with spatial resolution suitable for estimating part performance. Image (b) in FIG. 3A shows the spatial variations of the predicted and forecasted thermal gradients (dT/dx in units of k/m) and liquid-solid interface velocity (dx/dt in units of m/s) for a part with a cubic cross section in a given layer. Relatively small design changes and alterations can be carried out at this stage of the method of qualification to the associated CAD model geometry of the additively-manufactured metallic component 12 in order to preclude large transients in thermo-mechanical signatures that may lead to component defects such as cracking or porosity. Next, per this embodiment, the additively-manufactured metallic component 12 can be produced via an additive manufacturing process in which the in-situ sensors 14 are imbedded within the additively-manufactured metallic component 12 in the midst of the additive manufacturing process. Accompanying spatial and temporal resolutions can be provided based on the particular application. Then, data from measured thermal, mechanical, and chemical properties and signatures via the in-situ sensors 14 and the predicted and forecasted thermal signatures can be spliced together based upon, at least in part, similarity in signatures (see image (c) in FIG. 3A). In this embodiment, crystallographic texture (see image (d) in FIG. 3B) can be predicted and forecasted and microstructures can be predicted and forecasted using phenomenological models. Using the microstructural data, the spatial variation of the mechanical properties (e.g., hardness (see image (e) in FIG. 3B) or stress-strain diagram) can be described using a combination of phenomenological and data-science models. This data can then be mapped to describe the constitutive properties of the whole CAD model geometry of the additively-manufactured metallic component 12 with suitable spatial resolution. At this juncture, a statistical description of part performance of the additively-manufactured metallic component 12 can be provided, or the onset of cracks near component defects can be provided (see image (f) of FIG. 3B). Then, per this embodiment, full-scale testing can be performed to the additively-manufactured metallic component 12 for validation purposes. FIGS. 8A and 8B schematically depict another embodiment of the method of qualification of an additively-manufactured metallic component. As depicted, in general, a voxel-by-voxel description of microstructure and properties are enabled by the combined data from in-situ sensing and computational modeling.

Furthermore, with reference now to FIG. 2, an embodiment of the method of qualification of an additively-manufactured metallic component is schematically depicted. In this embodiment, image (a) presents existing and new designs of the additively-manufactured metallic component 12. Image (b) presents material feed stock and consistent measurement of powder characteristics for the additively-manufactured metallic component 12 for an accompanying additive manufacturing process. Image (c) presents selection of suitable additive manufacturing processing equipment for the particular process and application, such as the L-PBF AM process. Further, per this embodiment, image (d) presents in-situ characterization of surface and thermal signatures. Image (e) presents optional post-process heat treatment such as hot isostatic pressing. Image (f) presents detailed microstructure analyses and evaluation of microstructure heterogeneity. According to this embodiment, conformation of the microstructure and associated property heterogeneity is presented at image (g) via ex-situ characterization and heat transfer, and image (h) via computational and mechanics modeling. Image (i) presents mechanical testing and validation with the in-situ and/or ex-situ sensors 14 such as via digital image correlation that can highlight potential weak regions of the additively-manufactured metallic component 12. Image (j) presents the development of the associated data package for each and every part and additively-manufactured metallic component 12, possibly for regulatory bodies. Lastly, according to this embodiment, image (k) present final deployment of the final part and additively-manufactured metallic component 12 in the particular service and application.

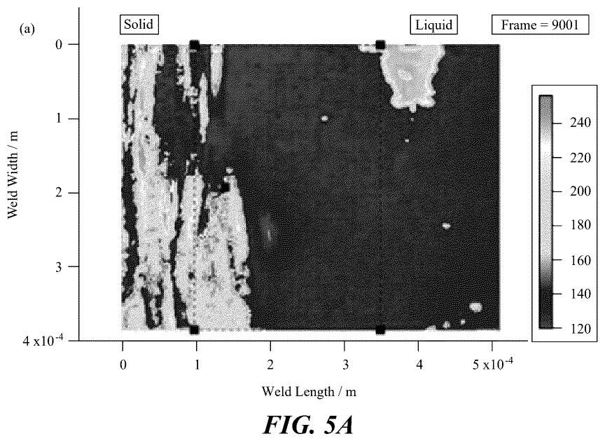

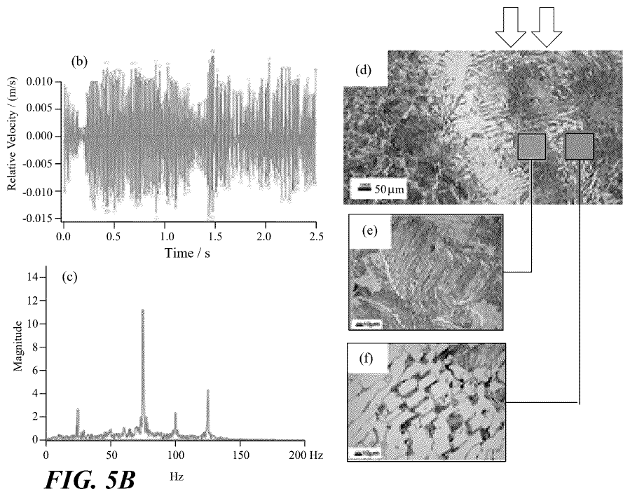

With reference now to FIGS. 5A and 5B, according to an embodiment, a foundational basis for the method of qualification is that local perturbation in thermal signatures may lead to changes in the microstructural distributions that will lead to scatter in properties. Evidence was provided amid analysis and evaluation of melt pool oscillations within a weld. It was noticed that subtle changes in liquid-solid interface velocities lead to perturbations in the phase transition of liquid steel either to a brittle delta-ferrite or tough fine-scale ferrite. These perturbations were rationalized using fundamental interface response function theories. Further, per this embodiment, this lead to the scientific hypothesis that the local changes in thermal, mechanical, and chemical signatures will lead to phase stability. It has been confirmed that the microstructural heterogeneity is related to the spatial and temporal variations of thermal, mechanical, and chemical signatures. FIGS. 5A and 5B present experimental evidence demonstrating the correlation between perturbations in liquid-solid interface velocity and resulting microstructural heterogeneity in a weld; still, skilled artisans will appreciate that other experiments may yield other results. Image (a) is an image of a snapshot from a movie capturing the transients in the melt pool solidification; in the image, the left side is the solid region and the right side is the liquid region. Image (b) presents results of analyzing the transients in liquid-solid interface velocity as a function of time which shows the growth and dissolution of the solid. Image (c) presents frequency distribution of the perturbations in liquid-solid interface velocity correlated to pulses in the energy source and time-resolution of the optical camera. Image (d) presents optical microscopy of the perturbed region showing the changes in the phase selection as a function of location (50 μm resolution). Image (e) presents a high magnification image of the region showing the fine alpha-ferrite that forms from the austenite phase. Lastly, image (f) presents the coarse delta-ferrite that formed form the liquid. It has been shown that the delta ferrite leads to poor fracture toughness compared to the alpha ferrite microstructure.

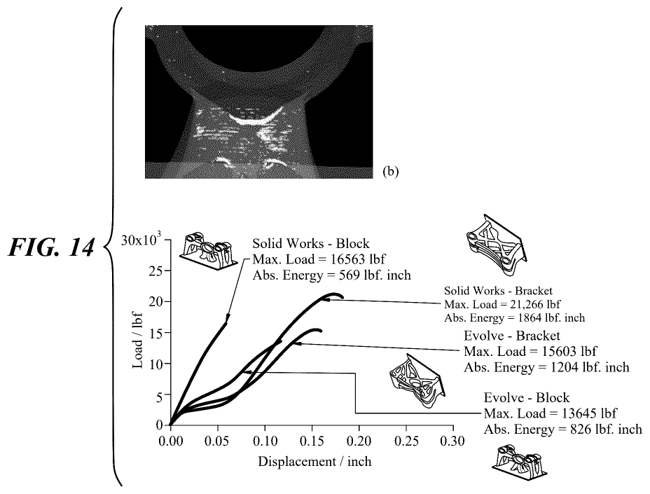

The method of qualification of additively-manufactured metallic components, per an embodiment, can involve technologies that are based on processing innovation, computational modeling, in-situ and/or ex-situ sensors, and robust data analysis methodologies. In an embodiment, it has been determined that topology optimization tools can be employed for design for additive manufacturing. Topology optimization software has been used, in an example, to design four representative brackets composed of Ti6Al4V and manufactured similarly via electron beam powder bed fusion (E-PBF) additive manufacturing. The results were then used from in-situ and/or ex-situ monitoring data to rationalize failure locations. This is presented in FIG. 14. In the figure, the graph depicts variations in performances of the four different topologized optimized parts through in-situ and/or ex-situ monitoring, and image (b) depicts the three-dimensional (3D) representations of defects identified from in-situ and/or ex-situ monitoring data showing the coalition of various defects close to the change in cross-section of the part due to large changes in layer time for additive manufacturing processing.

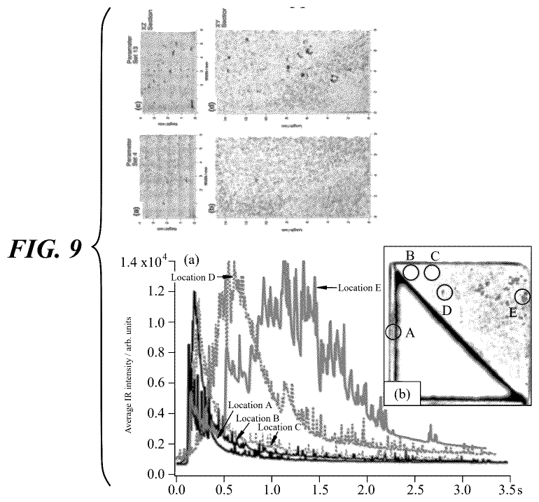

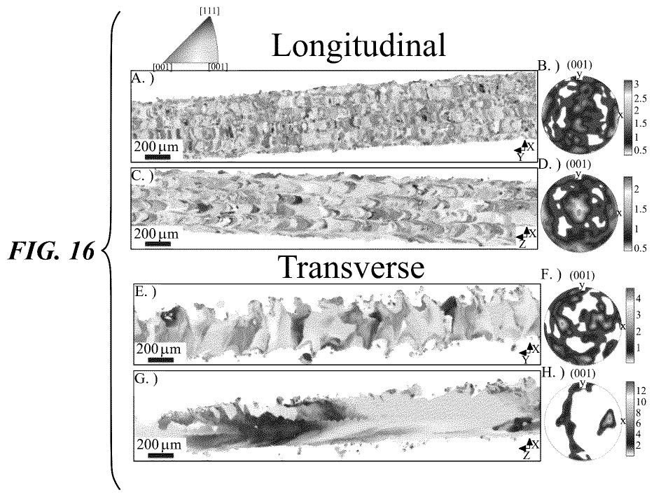

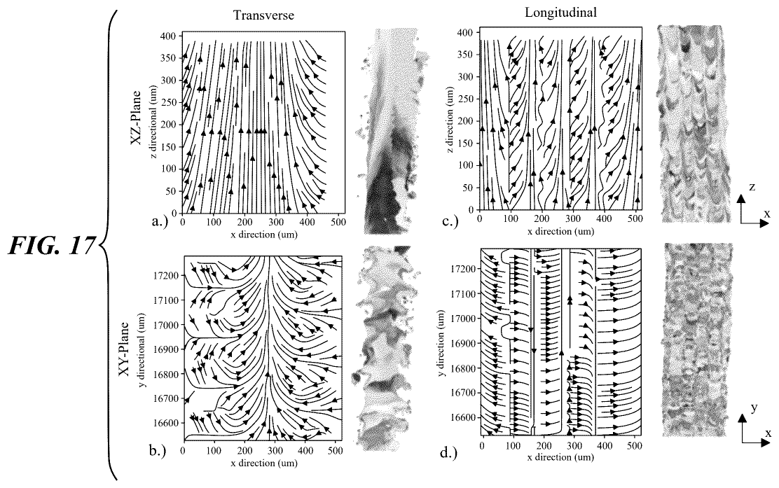

Furthermore, it has been determined that spatial and temporal variations of thermal gradients and liquid-solid interface velocity can be predicted and forecasted. Scan strategies for making Fe—Si soft magnetic ferritic alloy components were changed. The large changes in solidification grain structure were then rationalized by predicting the thermal gradients using a public domain computational fluid dynamics software. This is presented in FIG. 17. The figure shows calculated thermal gradient streamlines based on OpenFoam® (open domain computational fluid dynamic software) results that show striking similarity to the EBSD microstructures from samples produced with transverse and longitudinal scan strategies in the as-built condition. Moreover, FIG. 16 presents schematic depictions demonstrating correlation of additive manufacturing processes to control magnetic properties, the additive manufacturing process being a laser powder bed fusion (L-PBF) process of Fe—Si soft magnetic alloy component. Further, it has been determined that thermal signatures can be measured in different locations in complex structures made by additive manufacturing. An infrared camera was used with sufficient time resolution and a large field of view to track the spatial and temporal variations of thermal signatures during additive manufacturing of nickel-based alloys. The infrared signatures were then analyzed. Locations of sub-surface defects were identified using the resulting data. The calculations were confirmed using X-ray tomography observations. This is presented in FIG. 9. The figure presents an overview of thermal infrared (IR) signatures measured at five separate locations identified at A, B, C, D, and E in the somewhat complex component geometry shown in the window (b). The slow decay of the IR signatures is correlated to the observation of sub-surface defects under the locations D and E.

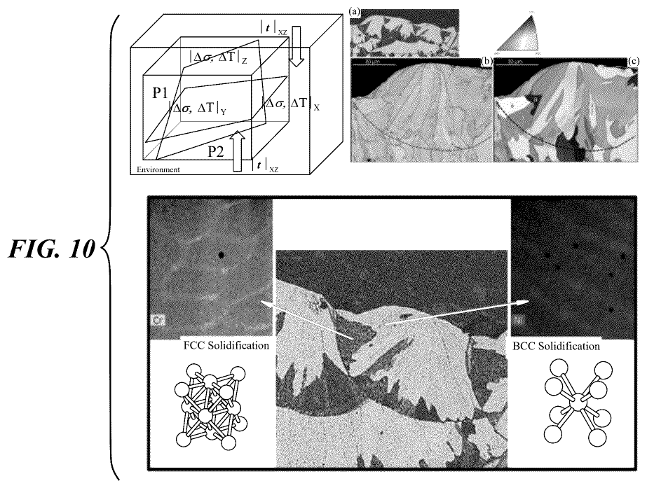

Moreover, the grain/phase structure evolution during additive manufacturing can be predicted and forecasted. During routine additive manufacturing of 316L stainless steel parts via laser powder bed fusion (L-PBF) additive manufacturing process, a somewhat unique microstructural contrast has been observed near the melt pool boundary—it has been named a “fish-scale” structure. This is presented in FIG. 10. The figure presents an overview of additive manufacturing solidification microstructure (i.e., fish-scale) near and far from associated melt pool boundaries. In the figure, the darker regions originally solidified as FCC with chromium partitioning to the liquid, and the brighter regions solidified as BCC with nickel partitioning to the liquid. This was predicted and forecasted with the use of interface response function models. The interface response function model rationalized these microstructural changes to spatial and temporal variation of liquid-solid interface velocity. The interface response function model predicted and forecasted that the darker regions solidified as austenite (FCC crystal structure) and the brighter regions solidified as ferrite (BCC crystal structure) and then transformed to FCC crystal structure through a somewhat massive transformation.

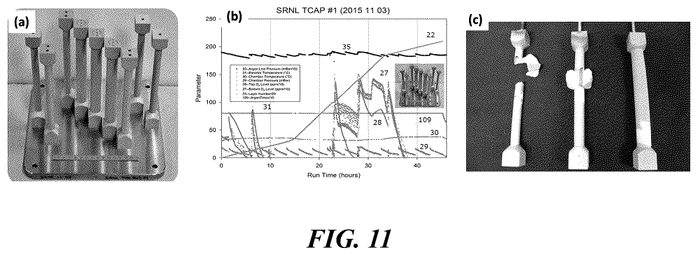

Furthermore, it has been observed that spatial distributions in process parameter variations lead to weak links in an additively-manufactured metallic component and part. This may be more suitable for smaller and mid-sized organizations, as opposed to larger organizations, although could also be suitable for such larger organizations. This is presented in FIG. 11. In the figure, image (a) presents an overview of pressure retaining tube parts made via a laser powder bed fusion (L-PBF) additive manufacturing process; image (b) is a graph showing measured process data pressure, temperature, and oxygen content as a function of time for a 40-hour build; and image (c) presents burst test pressurization results for some of the geometries of image (a). The data in the graph of image (b) shows process perturbations at the hour 23 mark. In the associated research, multiple stainless-steel pressure tube components were made via the L-PBF additive manufacturing process. During the L-PBF additive manufacturing process, relevant environmental conditions (e.g., pressure, temperature, and oxygen content) were collected with the use of sensors that are capable of being deployed within the additive manufacturing equipment. The premature failure of the pressure tube components were correlated to process perturbations.

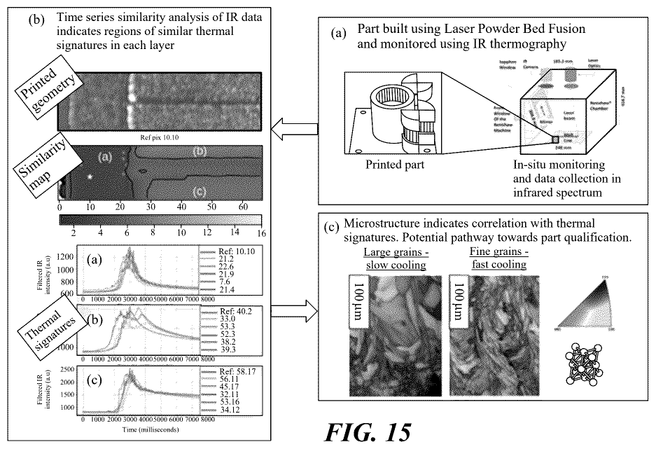

Yet further, per an embodiment, the method of qualification of additively-manufactured metallic components can be scaled via data science methodologies based on the spatial and temporal variations of thermal, mechanical, and chemical signatures in order to compare thermal, mechanical, and chemical signatures for qualification purposes. Dissimilarity analysis was used in order to identify regions that may undergo similar signatures and exhibit identical properties to design the appropriate representative volume elements for the computational analysis of the full component. This is presented in FIG. 15. The figure shows a schematic depiction of an overview of steps used for dissimilarity analysis in order to compare thermal signatures measured during additive manufacturing. In particular, boxed depiction (a) shows methodology for capturing transient infrared (IR) thermal signatures, boxed depiction (b) shows time-series dissimilarity analysis, and boxed depiction (c) shows grouping of thermal signatures based on similarity index. In (a), the additively-manufactured metallic component and part was made via a laser powder bed fusion (L-PBF) additive manufacturing process, and was monitored via infrared (IR) thermography. In-situ and/or ex-situ monitoring and data collection in the IR spectrum are shown. In (b), time series similarity analysis of IR data indicates regions of similar thermal signatures in each layer. In (c), microstructure indicates correlation with thermal signatures, presenting a potential pathway towards part qualification.

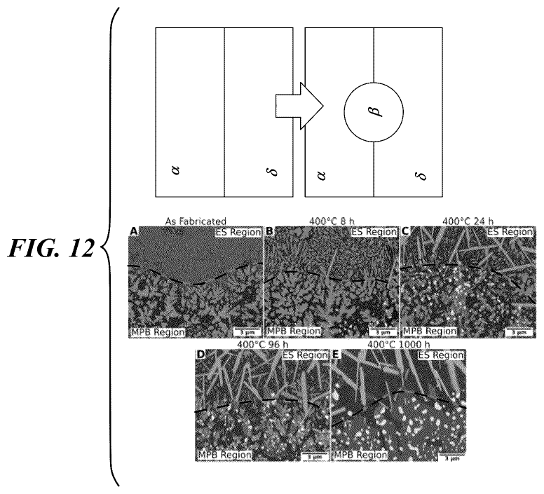

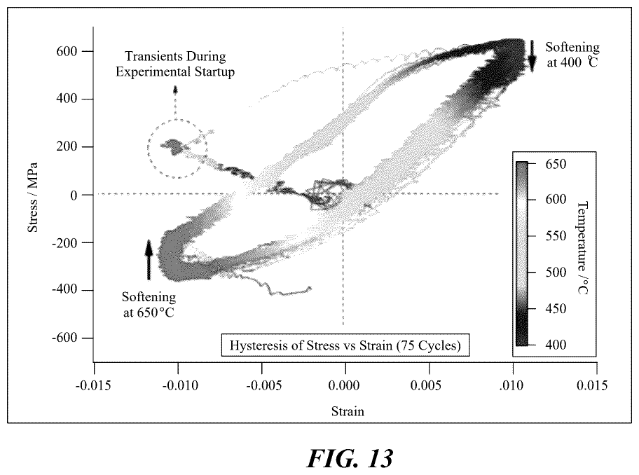

Furthermore, FIG. 12 is a schematic depiction demonstrating predicting solid-state transformation microstructure (cascading microstructure), and FIG. 13 is a schematic depiction demonstrating correlation of thermomechanical effects on solid-state phase transformations for additively-manufactured Ti-6Al-4V components.

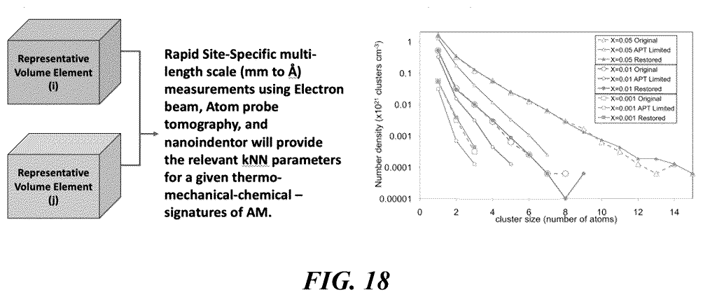

In a further embodiment, and with reference now to FIG. 18, structural and functional properties of the representative volume element can be correlated to atomic arrangements in different length scales, certain experimental procedures and activities described elsewhere in connection with other embodiments may be limited or altogether obviated. Relatively rapid ex-situ characterization of samples in different length scales (mm to A) can be carried out, and the kl level nearest neighbor interactions (kNN) between atoms can be quantified. The kNN parameters can be correlated to the structural and functional properties of the particular materials. Therefore, it is believed, integration of kNN technology can reduce the associated cost and time for deployment of the method of qualification of additively-manufactured metallic components, according to this embodiment.

In general, while a multitude of embodiments have been depicted and described with a multitude of components and steps in each embodiment, in alternative embodiments the components and steps of various embodiments could be intermixed, combined, and/or exchanged for one another. In other words, components described in connection with a particular embodiment are not necessarily exclusive to that particular embodiment.

As used herein, the terms “general” and “generally” and “substantially” and “approximately” and their grammatical variations are intended to account for the inherent degree of variance and imprecision that is often attributed to, and often accompanies, any design and manufacturing process, including engineering tolerances—and without deviation from the relevant functionality and intended outcome such that mathematical precision and exactitude is not implied and, in some instances, is not possible. In other instances, the terms “general” and “generally” and “substantially” and “approximately” and their grammatical variations are intended to represent the inherent degree of uncertainty that is often attributed to any quantitative comparison, value, and measurement calculation, or other representation.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

Those of skill in the art will understand that modifications (additions and/or removals) of various components of the substances, formulations, apparatuses, methods, systems, and embodiments described herein may be made without departing from the full scope and spirit of the present disclosure, which encompass such modifications and any and all equivalents thereof.

What is claimed is:

1. A method of qualification of an additively-manufactured metallic component, the method comprising:
situating a plurality of sensors at least adjacent the additively-manufactured metallic component;
measuring thermal properties of the additively-manufactured metallic component at a plurality of representative volume elements of the additively-manufactured metallic component via said plurality of sensors, measuring mechanical properties of the additively-manufactured metallic component at said plurality of representative volume elements via said plurality of sensors, and measuring chemical properties of the additively-manufactured metallic component at said plurality of representative volume elements via said plurality of sensors; and
simulating thermal properties of the additively-manufactured metallic component at said plurality of representative volume elements, simulating mechanical properties of the additively-manufactured metallic component at said plurality of representative volume elements, and simulating chemical properties of the additively-manufactured metallic component at said plurality of representative volume elements.

2. The method of qualification of the additively-manufactured metallic component as set forth in claim 1, wherein the measured thermal, mechanical, and chemical properties are measured spatial and temporal thermal, mechanical, and chemical properties of the additively-manufactured metallic component, and the simulated thermal, mechanical, and chemical properties are simulated spatial and temporal thermal, mechanical, and chemical properties of the additively-manufactured metallic component.

3. The method of qualification of the additively-manufactured metallic component as set forth in claim 1, further comprising using the measured thermal, mechanical, and chemical properties of the additively-manufactured metallic component and the simulated thermal, mechanical, and chemical properties of the additively-manufactured metallic component in order to forecast microstructure heterogeneity of the additively-manufactured metallic component.

4. The method of qualification of the additively-manufactured metallic component as set forth in claim 3, further comprising mapping the forecasted microstructure heterogeneity of the additively-manufactured metallic component onto a computer-aided design model of the additively-manufactured metallic component.

5. The method of qualification of the additively-manufactured metallic component as set forth in claim 4, further comprising providing estimated component defects of the additively-manufactured metallic component based on the mapped forecasted microstructure heterogeneity of the additively-manufactured metallic component.

6. The method of qualification of the additively-manufactured metallic component as set forth in claim 1, wherein said plurality of sensors measures thermophysical properties at said plurality of representative volume elements, measures thermo-mechanical properties at said plurality of representative volume elements, or measures both thermophysical and thermo-mechanical properties at said plurality of representative volume elements.

7. The method of qualification of the additively-manufactured metallic component as set forth in claim 1, wherein the method of qualification of the additively-manufactured metallic component is initiated with an approximate end design of the additively-manufactured metallic component.

8. The method of qualification of the additively-manufactured metallic component as set forth in claim 1, further comprising forecasting thermal signatures of the additively-manufactured metallic component, and using the forecasted thermal signatures and the measured thermal, mechanical, and chemical properties of the additively-manufactured metallic component in order to forecast microstructural heterogeneity of the additively-manufactured metallic component.

9. A method of qualification of an additively-manufactured metallic component, the method comprising:
forecasting thermal signatures of the additively-manufactured metallic component;
situating a plurality of sensors at least adjacent the additively-manufactured metallic component;
measuring thermal signatures of the additively-manufactured metallic component at a plurality of representative volume elements of the additively-manufactured metallic component via said plurality of sensors, measuring mechanical signatures of the additively-manufactured metallic component at said plurality of representative volume elements via said plurality of sensors, and measuring chemical signatures of the additively-manufactured metallic component at said plurality of representative volume elements via said plurality of sensors; and
using the forecasted thermal signatures and the measured thermal, mechanical, and chemical signatures of the additively-manufactured metallic component in order to forecast microstructural heterogeneity of the additively-manufactured metallic component.

10. The method of qualification of the additively-manufactured metallic component as set forth in claim 9, further comprising simulating thermal signatures of the additively-manufactured metallic component at said plurality of representative volume elements, simulating mechanical signatures of the additively-manufactured metallic component at said plurality of representative volume elements, and simulating chemical signatures of the additively-manufactured metallic component at said plurality of representative volume elements.

11. The method of qualification of the additively-manufactured metallic component as set forth in claim 10, further comprising using the simulated thermal, mechanical, and chemical signatures of the additively-manufactured metallic component in order to forecast microstructural heterogeneity of the additively-manufactured metallic component.

12. The method of qualification of the additively-manufactured metallic component as set forth in claim 9, wherein the forecasted thermal signatures are forecasted spatial and temporal thermal signatures of the additively-manufactured metallic component, and the measured thermal, mechanical, and chemical signatures are measured spatial and temporal thermal, mechanical, and chemical signatures of the additively-manufactured metallic component.

13. The method of qualification of the additively-manufactured metallic component as set forth in claim 9, further comprising mapping the forecasted microstructure heterogeneity of the additively-manufactured metallic component onto a computer-aided design model of the additively-manufactured metallic component.

14. The method of qualification of the additively-manufactured metallic component as set forth in claim 13, further comprising providing estimated component defects of the additively-manufactured metallic component based on the mapped forecasted microstructure heterogeneity of the additively-manufactured metallic component.

15. The method of qualification of the additively-manufactured metallic component as set forth in claim 9, wherein the forecasted microstructural heterogeneity of the additively-manufactured metallic component are based at least in part on similarities exhibited among the forecasted thermal signatures and the measured thermal, mechanical, and chemical signatures of the additively-manufactured metallic component.

16. The method of qualification of the additively-manufactured metallic component as set forth in claim 9, wherein the method of qualification of the additively-manufactured metallic component is initiated with an approximate end design of the additively-manufactured metallic component.

17. The method of qualification of the additively-manufactured metallic component as set forth in claim 9, wherein said plurality of sensors measures thermophysical properties at said plurality of representative volume elements, measures thermo-mechanical properties at said plurality of representative volume elements, or measures both thermophysical and thermo-mechanical properties at said plurality of representative volume elements.

18. A method of qualification of an additively-manufactured metallic component, the method comprising:
forecasting spatial and temporal thermal signatures of the additively-manufactured metallic component:
situating a plurality of sensors to make measurements at a plurality of representative volume elements of the additively-manufactured metallic component;
measuring spatial and temporal thermal signatures of the additively-manufactured metallic component at said plurality of representative volume elements via said plurality of sensors, measuring spatial and temporal mechanical signatures of the additively-manufactured metallic component at said plurality of representative volume elements via said plurality of sensors, and measuring spatial and temporal chemical signatures of the additively-manufactured metallic component at said plurality of representative volume elements via said plurality of sensors; and
using the forecasted spatial and temporal thermal signatures and the measured spatial and temporal thermal, mechanical, and chemical signatures of the additively-manufactured metallic component in order to forecast microstructural heterogeneity of the additively-manufactured metallic component, the forecasted microstructural heterogeneity of the additively-manufactured metallic component being based at least in part on similarities exhibited among the forecasted spatial and temporal thermal signatures and the measured spatial and temporal thermal, mechanical, and chemical signatures of the additively-manufactured metallic component;
wherein the method of qualification of the additively-manufactured metallic component is initiated with an approximate end design of the additively-manufactured metallic component.

19. The method of qualification of the additively-manufactured metallic component as set forth in claim 18, further comprising:
simulating spatial and temporal thermal signatures of the additively-manufactured metallic component at said plurality of representative volume elements, simulating spatial and temporal mechanical signatures of the additively-manufactured metallic component at said plurality of representative volume elements, and simulating spatial and temporal chemical signatures of the additively-manufactured metallic component at said plurality of representative volume elements; and
using the simulated spatial and temporal thermal, mechanical, and chemical signatures of the additively-manufactured metallic component in order to forecast microstructural heterogeneity of the additively-manufactured metallic component.

20. The method of qualification of the additively-manufactured metallic component as set forth in claim 18, further comprising:
mapping the forecasted microstructure heterogeneity of the additively-manufactured metallic component onto a computer-aided design model of the additively-manufactured metallic component; and
providing estimated component defects of the additively-manufactured metallic component based on the mapped forecasted microstructure heterogeneity of the additively-manufactured metallic component.
